(19) United States
(12) Patent Application Publication
(10) Pub. No.: US 2019/0048992 A1
(43) Pub. Date: Feb. 14, 2019

(54) SYSTEM FOR CONTROLLING A VEHICLE TRANSMISSION SUMP FLUID LEVEL

(71) Applicant: GM GLOBAL TECHNOLOGY OPERATIONS LLC, DETROIT, MI (US)

(72) Inventors: Bradley A. Buczkowski, Canton, MI (US); Kelly Eber, Oxford, MI (US)

(21) Appl. No.: 15/674,592

(22) Filed: Aug. 11, 2017

(51) Int. Cl. F16H 57/04; F16K 31/122

(52) U.S. Cl. CPC F16H 57/0447; F16K 31/1221

(57) ABSTRACT

A transmission for a vehicle propulsion system includes a transmission housing defining a sump volume and valve body side cover volume separated by a side wall from the sump volume, a valve operable to selectively connect the valve body side cover volume with the sump volume through a fluid flow passage, a source of selectively pressurizable fluid, and an orifice connecting the source of selectively pressurizable fluid to the fluid flow passage.

### FIELD

The present disclosure relates to a vehicle transmission sump fluid level control system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Many conventional vehicle propulsion systems include a transmission which relies upon a supply of hydraulic fluid for operation. The fluid in the transmission serves many functions, may be circulating throughout the transmission, and returns to a sump reservoir where it may be stored for further use. The level of the fluid in the sump and throughout the transmission should be reliably maintained. A fluid level which is too low may result in an inadequate supply of fluid, ingestion of air, and a fluid level which is too high may result in spin losses, increase in friction which may lead to decreased durability, increased potential for component failure, and increased heat, and many other problems that may be caused by an unreliable level of fluid in the sump.

Additionally, a fluid level in the sump which is too high may result in rotating components in the transmission causing a mixing between the fluid and air. In extreme cases, a high amount of mixing may result in a frothing that increases the overall volume of the fluid to the point where there may be a potential for overflow of the fluid out of the transmission case and/or loss of fluid.

The transmission sump also permits the fluid to settle which enables particulates to settle to the bottom of the sump and also enables any air to permeate out of the fluid. It is desirable that the fluid does not include any air mixed with the fluid. Air that may be mixed within the fluid may make it quite difficult to control operation of components of a transmission when reliable operation of those components requires that the fluid be incompressible. Air that may be entrained in the fluid may make it difficult to reliably control the transmission because of the compressibility of the air.

Transmission fluid may be sensitive to temperature. For example, the volume of the fluid may increase during high temperature operation. When the volume of the fluid varies, or when the level of the fluid in the sump is too high, it may be desirable to find another location to store the fluid. Many transmissions for vehicle propulsion systems may store excess and/or hot fluid in a volume enclosed by a valve body side cover that is attached to a transmission housing. The valve body side cover may enclose controls for the transmission, such as, for example, electrically controlled solenoids, a solenoid body enclosing the solenoids, valves, and a valve body enclosing the valves. These controls may be selectively operated to control operation of the transmission. The volume enclosed between the valve body side cover and a side wall of the transmission case may be used to store transmission fluid separately from the sump area. The level of fluid in the sump may be better controlled by controlling a flow of fluid from the valve body side cover volume into the sump. The flow of fluid between these two volumes may have relied upon a gravity feed system. These systems provide a flow when the level of fluid in the valve body side cover volume reaches a high enough level to flow into a channel. The fluid then may drain into the sump under the force of gravity.

Alternatively, the flow of fluid between these two volumes may incorporate valves which may open or close based upon the temperature and/or which may be separately controlled. However, under certain conditions, control over the flow of fluid between the valve body side cover volume and the sump may pose challenges. For example, the viscosity of the fluid may vary in response to the temperature of the fluid. In cold conditions, the fluid may have a higher viscosity which may result in a flow which may be lower than desired. A lower flow of fluid from the valve body side cover volume may result in a lower than desired level of fluid within the sump. A low supply of fluid in the sump may result in starvation of a sump pump which otherwise operates to provide fluid for operation of the transmission.

### SUMMARY

In an exemplary aspect, a transmission for a vehicle propulsion system includes a transmission housing defining a sump volume and valve body side cover volume separated by a side wall from the sump volume, a valve operable to selectively connect the valve body side cover volume with the sump volume through a fluid flow passage, a source of selectively pressurizable fluid, and an orifice connecting the source of selectively pressurizable fluid to the fluid flow passage.

In another exemplary aspect, the source of selectively pressurizable fluid is pressurized a flow of fluid through the orifice has a higher velocity than a flow through the fluid flow passage.

In another exemplary aspect, the orifice is positioned relative to the fluid flow passage such that the higher velocity of fluid from the orifice into the fluid flow passage results in a lowering of pressure in the fluid flow passage which increases the volume of flow through the fluid flow passage from the valve body side cover volume into the sump volume.

In another exemplary aspect, the source of selectively pressurizable fluid determines operation of the valve based upon the pressure of the selectively pressurized fluid exceeding a predetermined threshold.

In another exemplary aspect, a solenoid operable to selectively provide the pressurizable fluid to a control inlet for the valve and to the orifice.

In another exemplary aspect, the fluid flow passage includes an outlet from the valve and the orifice connects to the fluid flow passage downstream of the valve outlet.

In another exemplary aspect, the valve is housed in a valve body housing a plurality of valves.

In another exemplary aspect, the transmission further includes a solenoid body housing a plurality of solenoid valves each of which selectively control a flow of fluid into the valve body.

In this manner, control over the flow of transmission fluid between the valve body side cover and the transmission sump may be improved over a wider range of operating conditions. For example, in colder conditions when the viscosity of the transmission fluid may increase, flow between the valve body side cover and the transmission sump may continue to be provided thereby maintaining a reliable level and source of fluid in the transmission sump.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a schematic illustration of a vehicle transmission valve body side cover drain down system;

FIG. 2 is partial, cross-sectional, perspective view of an exemplary transmission for a vehicle propulsion system;

FIG. 3 is a close-up, elevational view of a portion of a side wall of a transmission case;

FIG. 4 illustrates a second spacer plate;

FIG. 5 illustrates a valve body;

FIG. 6 illustrates a portion of a first spacer plate;

FIG. 7 illustrates cross-sectional, elevation view along line A-A of FIG. 2;

FIG. 8 is a schematic illustration of a vehicle transmission valve body side cover drain down system in accordance with an exemplary embodiment of the present disclosure;

FIG. 9 is a perspective view of a solenoid body which has been modified in accordance with an exemplary embodiment of the present disclosure;

FIG. 10 is a graph illustrating flow rates between a valve body side cover housing and transmission sump for a variety of configurations;

FIG. 11A illustrates an exemplary valve body; and

FIG. 11B illustrates an exemplary first spacer plate.

### DETAILED DESCRIPTION

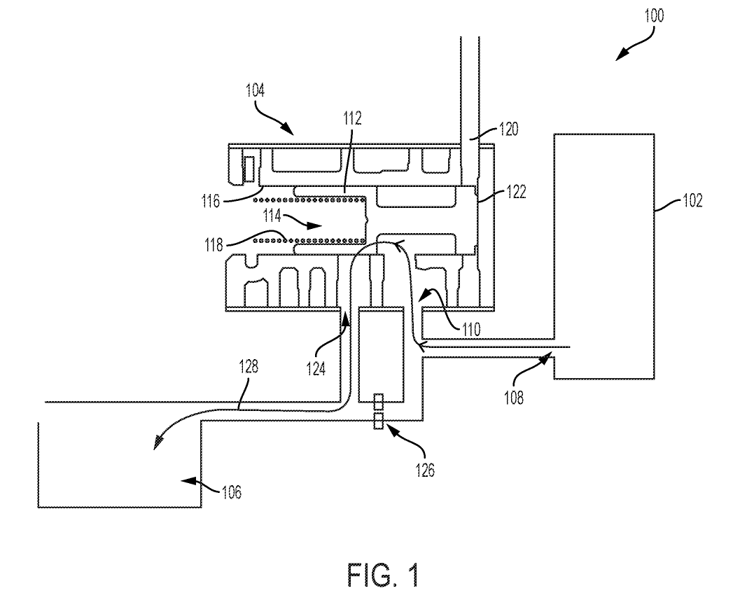

FIG. 1 is a schematic illustration of a vehicle transmission valve body side cover drain down system 100. The vehicle transmission valve body side cover drain down system 100 includes a valve body side cover 102 defining a volume between the valve body side cover and a transmission case which may be used as storage for fluid. The system 100 includes a sump level control valve assembly 104 that is selectively operable to open a flow path from the volume enclosed by the valve body side cover 102 to a transmission sump 106. An outlet 108 from the volume enclosed by the valve body side cover 102 is in fluid communication with an inlet 110 of the sump level control valve assembly 104. The sump level control valve assembly 104 includes a piston 112 which is slidable within a valve chamber 114 defined by valve chamber wall 116. The piston 112 is biased toward a closed position by a valve spring 118. The sump level control valve assembly 104 further includes a valve control inlet 120 which is in fluid communication with a source (not shown) of selectively pressurized fluid. The source of selectively pressurized fluid may be, for example, a solenoid valve housed in a solenoid body which is selectively actuable to apply a pressurized fluid to the valve control inlet 120. When a source of pressurized fluid is applied to the valve control inlet 120 the fluid applies a valve opening force to a face 122 of the piston 112. That force opposes the biasing force of the valve spring 118 and, when that force is sufficient to overcome the biasing force of the valve spring 118, the piston 112 moves to an open position (not shown) which opens a flow path through the sump level control valve assembly 104 between the inlet 110 of the sump level control valve assembly 104 and an outlet 124. In this manner, when the sump level control valve assembly 104 opens, fluid in the valve body side cover 102 may then flow through the outlet 108 of the valve body side cover 102, through the inlet 110 of the sump level control valve 104, through the sump level control valve 104, exit the sump level control valve assembly 104 at the outlet 124, and subsequently flow into the transmission sump 106.

The vehicle transmission valve body side cover drain down system 100 may also include a drain down orifice 126 that is positioned within a secondary flow path between the outlet 108 of the valve body side cover 102 and the transmission sump 106. The size of the orifice 126 may be selected such that the flow of fluid from outlet 108 into the transmission sump 106 is significantly less than the flow of fluid through the sump level control valve assembly 104 when the sump level control valve is in an open configuration. In general, the orifice 126 is provided for the purpose of draining fluid from the valve body side cover 102 when the vehicle and vehicle transmission is shut down for an extended period of time. The size of the orifice 126 is selected to be small enough such that the flow through the orifice 126 is significantly less than the rate at which a flow of fluid may enter the valve body side cover 102 during operation such that fluid may be stored within the valve body side cover 102.

FIG. 1 further illustrates that the flow path, as illustrated with flow path line 128, through the sump level control valve assembly 104 when the sump level control valve is in the open configuration, is quite complex and includes multiple changes in direction and restrictions through which fluid flowing along the flow path 128 must overcome before reaching the transmission sump 106. In some conditions, the flow of fluid from the volume enclosed by the valve body side cover 102 to the transmission sump 106 may be less than desired. For example, in general, the viscosity of the transmission fluid may increase as the temperature of the fluid decreases. Any increase in viscosity causes an increase in flow resistance through the flow path 128. At certain low temperatures, the viscosity of the fluid may increase to the point where the flow of fluid from the volume enclosed by the valve body side cover 102 to the transmission sump 106 is reduced and/or eliminated which may lead to a lower than desired level of fluid in the transmission sump 106.

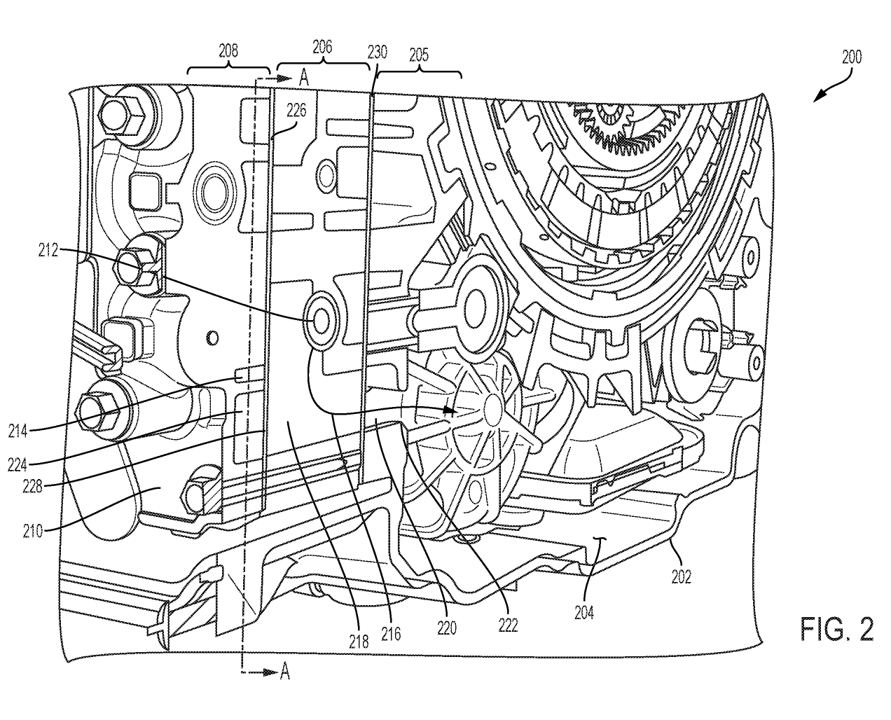

FIG. 2 is partial, cross-sectional, perspective view of an exemplary transmission 200 for a vehicle propulsion system. The transmission 200 includes a transmission case 202 (or housing) that encloses multiple components of the transmission 200. A lower portion of the transmission case 202 defines a volume which may be referred to as the transmission sump 204. In normal operation, the transmission sump 204 may hold a volume of transmission fluid (not shown) which may then be used as a source for transmission fluid to operate components within the transmission 200. On a side of the transmission case 202, a valve body side cover (not shown) may be attached which, together with a side wall 205 of the transmission case 202 may define a volume which may enclose a valve body 206, a solenoid body 208, and a valve body side cover volume 210 (which is the volume enclosed by the valve body side cover and the side wall 205). The valve body side cover volume 210 may also be used to store transmission fluid. The partial, cross-sectional, perspective view of FIG. 2 at least partially illustrates a flow path between the valve body side cover volume 210 and the transmission sump 204 which may be selectively provided through operation of a sump level control valve 212 (only a portion of which is illustrated). Operation of the sump level control valve 212 may be controlled by the pressure of fluid within a valve control passage 214 in the solenoid body 208 which communicates with an inlet (not shown) to the sump level control valve 212. Operation of a solenoid valve (not shown) within the solenoid body 208 may selectively apply pressurized fluid into the valve control passage 214 which may then selectively cause the sump level control valve 212 to open a flow path between the valve body side cover volume 210 and the transmission sump 204 in a manner similar to that which was described previously with reference to FIG. 1. A flow path 216 illustrates the path along which fluid may flow when the sump level control valve 212 is opened from an outlet (not shown) of the sump level control valve 212 into a first volume 218 defined within the valve body 206, out of the first volume 218 and into a second volume 220 defined by the side wall 205 of the transmission case 202, through an outlet 222 of the side wall 205, and into the transmission sump 204.

The solenoid body 208 may further define a third volume 224 which is in fluid communication with the valve body side cover volume 210 through another passage (not illustrated). Between the solenoid body 208 and the valve body 206, a first spacer plate 226 may be positioned. The first spacer plate 226 may include a drain down orifice 228 which acts in manner similar to the orifice 126 described previously with reference to FIG. 1. As previously described, the drain down orifice 228 may provide a slow flow of fluid from the valve body side cover volume 210 to the transmission sump 204 which, over an extended period of time, may permit the fluid in the valve body side cover volume 210 to drain into the transmission sump 204.

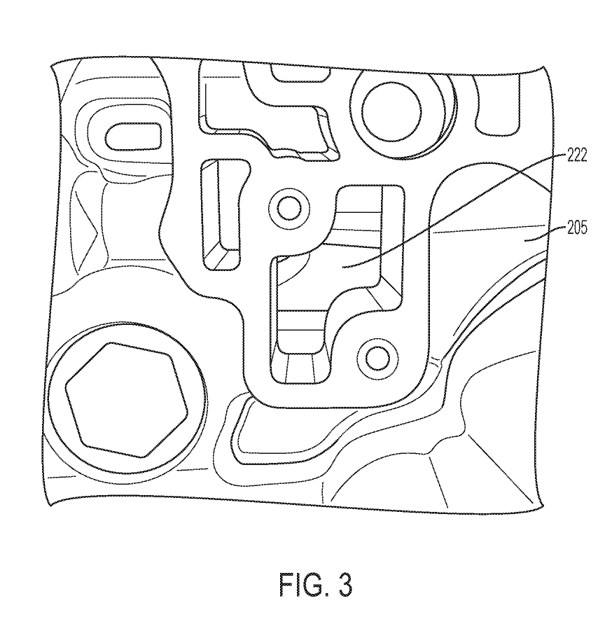

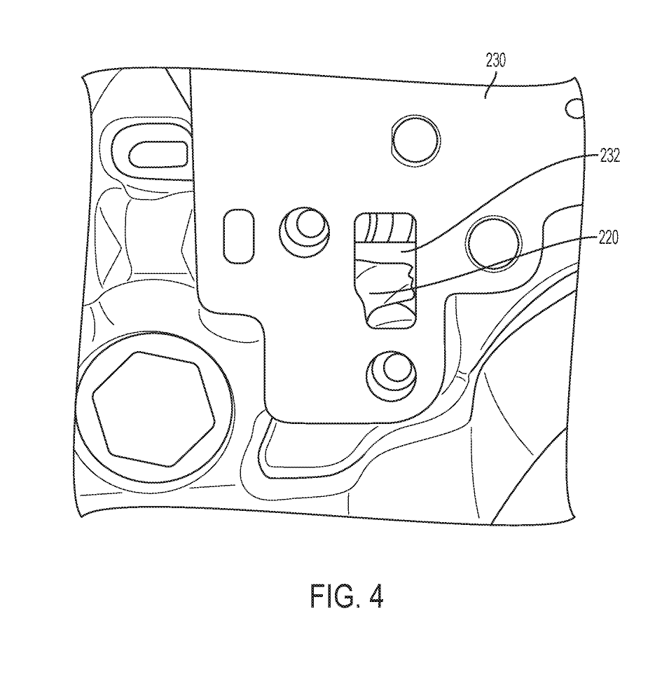

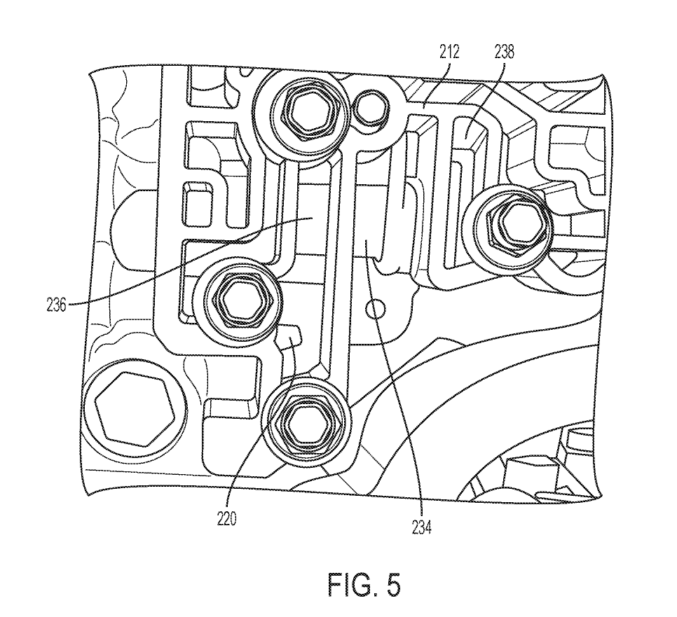

Referring now to FIGS. 3 through 7, additional structural details of the exemplary transmission 200 will be described. The direction of the perspective view of each of FIGS. 3-7 is the same. FIG. 3 is a close-up, elevational view of the side wall 205 of the transmission case 202. The view of FIG. 3 is looking from the valve body side of the side wall 205, through the outlet 220 and into the transmission sump 204. FIG. 4 illustrates a second spacer plate 230, which may be positioned between the side wall 205 and the valve body 206 (referring back also to FIG. 2). The outlet 220 in the side wall 205 is visible behind the second spacer plate 230 through a spacer plate outlet 232. FIG. 5 illustrates the valve body 206 positioned adjacent the second spacer plate 230. Again, the outlet 220 in the side wall 205 (and the transmission sump 204 behind it) is visible through the valve body 206. The valve body 206 houses the sump level control valve 212. A flow path is defined between the sump level control valve inlet 234 and the sump level control valve outlet 236 when the sump level control valve 212 is in an open configuration. The valve body 206 includes a valve control inlet 238. Selective application of a pressurized fluid into the valve control inlet 238 enables control of the sump level control valve 212 in a manner to that similarly described previously with reference to FIG. 1.

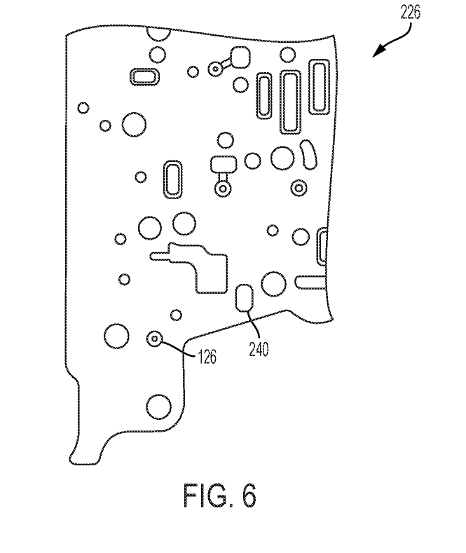

FIG. 6 illustrates a portion of the first spacer plate 226 which may be positioned between the valve body 206 and the solenoid body 208. The first spacer plate 226 includes the drain down orifice 126 described previously with reference to FIG. 2. The first spacer plate 226 further includes multiple other orifices which may each be provided for other functions or purposes to provide fluid communication between the solenoid body 208 and the valve body 206. The first spacer plate 226 includes a control valve opening 240 through which a supply of pressurized fluid may be selectively provided into the valve control inlet 238 for controlling operation of the sump level control valve 212.

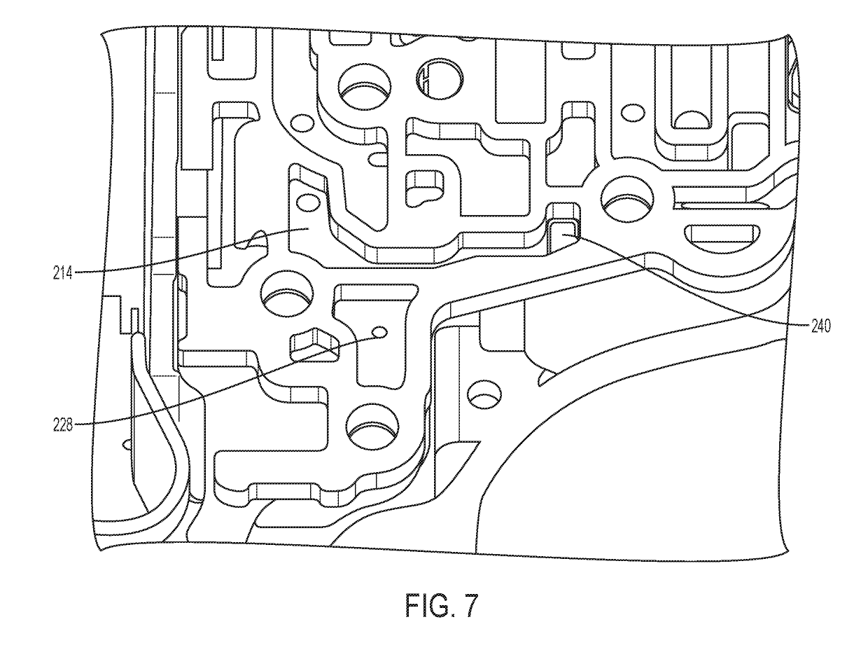

FIG. 7 illustrates an elevation view taken along cross-section line A-A of FIG. 2. A portion of the valve control passage 214 of the solenoid body 208 is visible in FIG. 7. As explained previously, operation of a solenoid (not shown) within the solenoid body 208 may selectively apply pressurized fluid into the valve control passage 214 which may then pass through the control valve opening 240 in the first spacer plate 226 (FIG. 6) and into the valve control inlet 238 in the valve body 206 to selectively operate the sump level control valve 212. FIG. 7 further illustrates the third volume 224 which may communicate with the valve body side cover volume 210 and the drain down orifice 126 in the first spacer plate 226.

As can be clearly understood with reference to FIGS. 1-7, the flow path between the volume that is enclosed by the valve body side cover and the transmission sump is quite convoluted. Under certain conditions, the flow from the valve body side cover volume and the transmission sump may not be sufficient. It is desirable to improve the flow into the transmission sump.

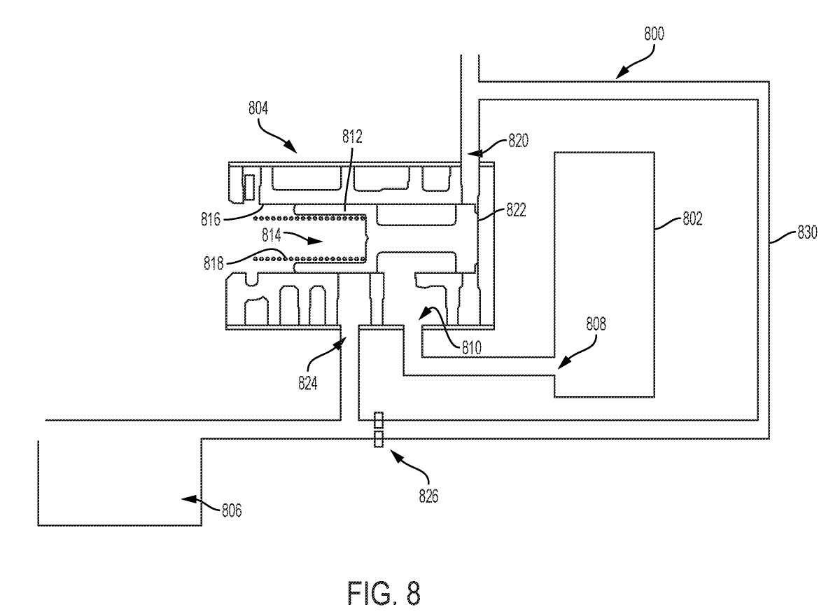

FIG. 8 schematically illustrates a vehicle transmission valve body side cover drain down system 800 in accordance with an exemplary embodiment of the present disclosure. The vehicle transmission valve body side cover drain down system 800 includes a valve body side cover 802 enclosing a volume which may be used as storage for fluid. The system 800 includes a sump level control valve 804 that is selectively operable to open a flow path from the volume enclosed by the valve body side cover 802 to a transmission sump 806. An outlet 808 from the volume enclosed by the valve body side cover 802 is in fluid communication with an inlet 810 of the sump level control valve 804. The sump level control valve 804 includes a piston 812 which is slidable within a valve chamber 814 defined by valve chamber wall 816. The piston 812 is biased toward a closed position by a valve spring 818. The sump level control valve 804 further includes a valve control inlet 820 which is in fluid communication with a source (not shown) of selectively pressurized fluid. The source of selectively pressurized fluid may be, for example, a solenoid valve housed in a solenoid body which is selectively actuable to apply a pressurized fluid to the valve control inlet 820. When a source of pressurized fluid is applied to the valve control inlet 820 the fluid applies a valve opening force to a face 822 of the piston 812. That force opposes the biasing force of the valve spring 818 and, when that force is sufficient to overcome the biasing force of the valve spring 818, the piston 812 moves to an open position (not shown) which opens a flow path through the sump level control valve 804 between the inlet 810 of the sump level control valve 804 and an outlet 824. In this manner, when the sump level control valve 804 opens, fluid in the valve body side cover 802 may then flow through the outlet 808 of the valve body side cover 802, through the inlet 810 of the sump level control valve 804, through the sump level control valve 804, exit the sump level control valve 804 at the outlet 824, and subsequently flow into the transmission sump 806.

In contrast to the vehicle transmission valve body side cover drain down system 100 of FIG. 1, the vehicle transmission valve body side cover drain down system 800 includes a secondary flow path 830 that provides fluid communication between the pressurized fluid source at the inlet 820 of the sump level control valve 804 and the transmission sump 806. In this manner, when a pressurized source of fluid is provided at the inlet 820 to open the sump level control valve 804, a portion of that pressurized fluid flows through the secondary flow path to a jet-assist orifice 826 which results in a flow of fluid exiting the jet-assist orifice 826. Since the pressure of the fluid entering the orifice is higher than the exit, the flow of fluid exiting the jet-assist orifice 826 is at a higher velocity than that of the flow of fluid that originates from the valve body side cover 830 and which extends to the transmission sump 806 via the sump level control valve 804. The higher velocity of fluid results in a lowering of the pressure in the flow downstream of the jet-assist orifice 826. Since the higher velocity flow and associated pressure is located adjacent to the outlet 824 the difference in pressure encourages and increases the flow through the sump level control valve 804. In this manner, even under less than ideal conditions, such as, for example, colder temperatures, flow from the valve body side cover 802 is maintained and/or improved.

In an exemplary embodiment, the vehicle transmission valve body side cover drain down system 100 illustrated schematically in FIG. 1 may be easily modified to match the configuration of the vehicle transmission valve body side cover drain down system 800 illustrated in FIG. 8. A fluid flow passage between the sump level control valve inlet 120/820 may be established to provide a source of pressurized fluid and the fluid flow passage between the drain down orifice 126 and the outlet 108 of the valve body side cover 102 may be closed. In this manner, with minor modifications, the existing drain down orifice 126 may then serve the different purpose and function of a jet-assist orifice 826 to improve the flow from the valve body side cover volume 802 into the transmission sump 806.

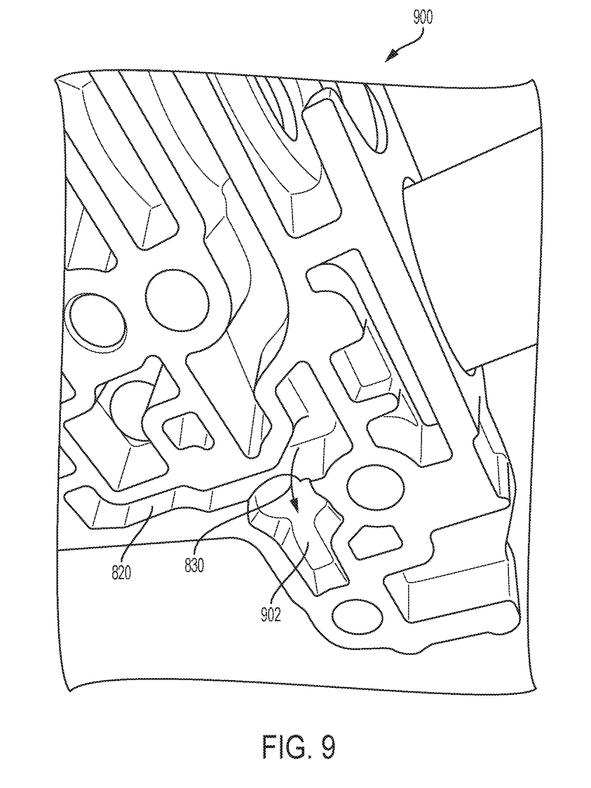

FIG. 9 is a perspective view of a solenoid body 900 which has been modified to provide the secondary flow path 830 and to block the outlet between the jet-assist orifice 826 and the outlet of the valve body side cover 802. For purposes of comparison, reference between FIG. 7 and FIG. 9 is helpful. The wall portion (not referenced) which separates the valve control passage 214 from fluidly communicating with the drain-down orifice 228 may be opened and/or removed to provide the secondary flow path 830 indicated with an arrow in FIG. 9. Further, the passage between the drain-down orifice 126 (now jet-assist orifice 826) and the valve body side cover volume 802 may be closed with a wall 902 or other means. The wall 902 prevents flow from the valve body side cover volume 802 flowing through the jet-assist orifice 826.

As explained above, the existing drain down orifice 126 that is provided in the first spacer plate 226 may adequately serve as the jet-assist orifice 826 in accordance with an exemplary embodiment of the present disclosure. However, the jet-assist orifice 826 may be moved and/or otherwise altered to improve the flow of fluid from the valve body side cover volume 802 and the transmission sump 806.

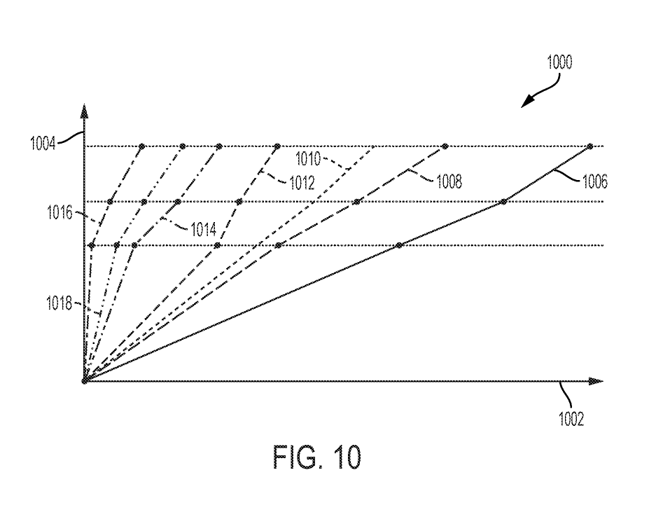

FIG. 10 is a graph 1000 illustrating the variances in flow between the valve body side cover housing and the transmission sump for varying configurations of a vehicle transmission valve body side cover drain down system. The horizontal axis 1002 corresponds to the volume of flow and the vertical axis 1004 corresponds to the level of fluid in the valve body side cover volume (also referred to as the “head” level). In a first configuration, the only separation between the valve cover side body volume and the transmission sump is the side wall of the transmission case which is substantially the same configuration illustrated in FIG. 2. The flow line 1006 represents the flow from the valve body side cover volume into the transmission sump in this configuration. As can be seen, the highest flow is possible in this configuration. However, this flow is not practically obtainable as the control elements for operating the transmission are not present.

The flow line 1008 illustrates the flow from the valve body side cover volume into the transmission sump when a stand pipe (or stand tube) is provided and when the complete control system is enclosed within the side cover (i.e. the valve body, valves, solenoid body, and solenoids). An exemplary stand tube is disclosed in co-assigned U.S. Pat. No. 7,766,126, the disclosure of which is incorporated herein in its entirety. The flow line 1010 illustrates the flow from the valve body side cover volume into the transmission sump when the stand pipe further includes a thermal element which further modulates the flow based upon the temperature of the fluid. The thermal element adds complexity and cost which is preferable to avoid.

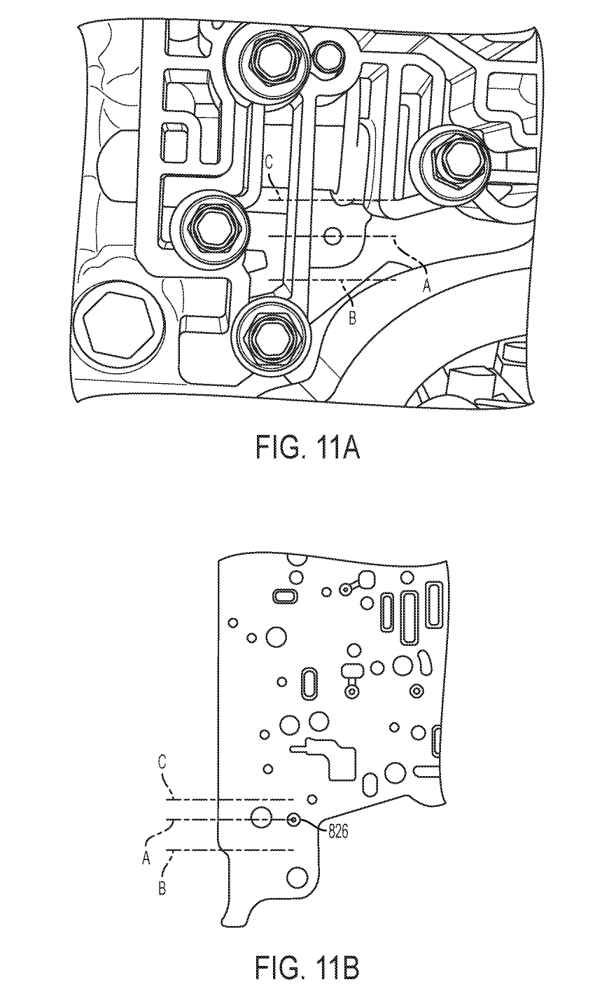

The remaining lines in graph 1000 illustrate the flow through different exemplary embodiments of the present disclosure. Line 1012 illustrates the flow from the valve body side cover volume into the transmission sump with the vehicle transmission valve body side cover drain down system 800 of FIG. 8, having the jet-assist orifice 826 positioned as illustrated in FIG. 6, and the modified solenoid body 900 illustrated by FIG. 9. Referring now also to FIGS. 11A and 11B, FIG. 11A illustrates the same view of the valve body 206 of FIG. 5 but also indicates alternative vertical positions for the jet-assist orifice 826 relative to the valve body 206. FIG. 11B also illustrates the same view of the first spacer plate 226 of FIG. 6, but further indicates the alternative vertical positions for the jet-assist orifice 826. The position of the jet-assist orifice 826 may be experimentally optimized in a manner similar to that described herein. The flow from the valve body side cover volume into the transmission sump that is illustrated by line 1012 corresponds to the vertical position line “A”. As can be seen in FIG. 11A, the vertical location “A” for the jet-assist orifice 826 in the first spacer plate 226 is slightly higher than the port in the side wall of the transmission case.

Moving the jet-assist orifice 826 to a lower vertical position corresponding to that of vertical position “B” in both of FIGS. 11A and 11B, results in a slightly lower volume of flow from the valve body side cover volume into the transmission sump as indicated by line 1014. Even though the jet-assist orifice 826 at vertical level B appears to directly “aim” through the port in the side wall of the transmission case and into the transmission sump, the flow that was experimentally measured was slightly lower than the flow 1012 measured when using an orifice at level “A”.

Positioning the jet-assist orifice 826 at a higher vertical level which is indicated at “C” in FIGS. 11A and 11B, an even lower volume of flow from the valve body side cover volume into the transmission sump was measured as indicated at line 1016.

For purposes of comparison, line 1018 illustrates the flow volume for the vehicle transmission valve body side cover drain down system 100 the components of which are discussed previously with reference to FIGS. 1-7. As is clearly illustrated, the modification to the vehicle transmission valve body side cover drain down system 100 to provide the vehicle transmission valve body side cover drain down system 800 in accordance with an exemplary embodiment of the present disclosure results in an improvement (an increase) of flow from the valve body side cover volume into the transmission sump to the flow which is illustrated with line 1012. This is a significant improvement and obviates many of the problems experienced with conventional systems which do not incorporate the features of the present disclosure.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A transmission for a vehicle propulsion system, the transmission comprising:
a transmission housing defining a sump volume and valve body side cover volume separated by a side wall from the sump volume;
a valve operable to selectively connect the valve body side cover volume with the sump volume through a fluid flow passage;
a source of selectively pressurizable fluid; and
an orifice connecting the source of selectively pressurizable fluid to the fluid flow passage.

2. The transmission of claim 1, wherein when the source of selectively pressurizable fluid is pressurized a flow of fluid through the orifice has a higher velocity than a flow through the fluid flow passage.

3. The transmission of claim 2, wherein the orifice is positioned relative to the fluid flow passage such that the higher velocity of fluid from the orifice into the fluid flow passage results in a lowering of pressure in the fluid flow passage which increases the volume of flow through the fluid flow passage from the valve body side cover volume into the sump volume.

4. The transmission of claim 1, wherein the source of selectively pressurizable fluid determines operation of the valve based upon the pressure of the selectively pressurized fluid exceeding a predetermined threshold.

5. The transmission of claim 1, further comprising a solenoid operable to selectively provide the pressurizable fluid to a control inlet for the valve and to the orifice.

6. The transmission of claim 1, wherein the fluid flow passage comprises an outlet from the valve and wherein the orifice connects to the fluid flow passage downstream of the valve outlet.

7. The transmission of claim 1, wherein the valve is housed in a valve body housing a plurality of valves.

8. The transmission of claim 7, further comprising a solenoid body housing a plurality of solenoid valves each of which selectively control a flow of fluid into the valve body.

9. A transmission for a vehicle propulsion system, the transmission comprising:
a transmission case at least partially defining a sump volume and including a side wall;
a valve body side cover defining a valve body side cover volume with the side wall of the transmission case;
a valve operable to selectively connect the valve body side cover volume to the sump volume through a first flow passage having an outlet in the side wall of the transmission case; and
a solenoid operable to selectively provide a pressurized fluid to a control port for the valve and to provide the pressurized fluid to an orifice in a wall of the first flow passage.

10. The transmission of claim 9, further comprising a valve body enclosed within the valve body side cover volume, wherein the valve is enclosed within the valve body.

11. The transmission of claim 10, further comprising a first spacer plate positioned between the valve body and the side wall of the transmission case.

12. The transmission of claim 10, further comprising a solenoid body enclosed within the valve body side cover volume, wherein the solenoid is housed within the solenoid body.

13. The transmission of claim 12, further comprising a second spacer plate positioned between the solenoid body and the valve body.

14. The transmission of claim 13, wherein the second spacer plate defines the orifice in the wall of the first flow passage.

15. The transmission of claim 14, wherein the solenoid body defines a second fluid passage that communicates with the control port of the valve and with the orifice in the wall of the first flow passage.

16. A vehicle transmission sump fluid level control system for controlling the fluid level in a transmission sump, the transmission including a transmission case at least partially defining a sump volume and including a side wall, a valve body side cover defining a valve body side cover volume with the side wall of the transmission case, a valve operable to selectively connect the valve body side cover volume to the sump volume through a first flow passage having an outlet in the side wall of the transmission case, and a solenoid operable to selectively provide a pressurized fluid to a control port for the valve, the system comprising a second flow passage connecting the pressurized fluid from the solenoid to an orifice in a wall of the first flow passage.

17. The system of claim 16, further comprising a valve body enclosed within the valve body side cover volume, wherein the valve is enclosed within the valve body.

18. The system of claim 17, further comprising a solenoid body enclosed within the valve body side cover volume, wherein the solenoid is housed within the solenoid body.

19. The system of 18, further comprising a spacer plate positioned between the solenoid body and the valve body.

20. The system of claim 19, wherein the spacer plate defines the orifice in the wall of the first flow passage.
